(19) United States
(12) Patent Application Publication
(10) Pub. No.: US 2026/0331372 A1
(43) Pub. Date: Oct. 22, 2026

(54) MULTILAYER ELECTRONIC COMPONENT

(71) Applicant: SAMSUNG ELECTRO-MECHANICS CO., LTD., Suwon-si (KR)

(72) Inventors: So Jung An, Suwon-si (KR); Yoo Jeong Lee, Suwon-si (KR); Jung Won Park, Suwon-si (KR); Chae Min Park, Suwon-si (KR); So Eun Choi, Suwon-si (KR); Jong Ho Lee, Suwon-si (KR)

(73) Assignee: SAMSUNG ELECTRO-MECHANICS CO., LTD., Suwon-si (KR)

(21) Appl. No.: 19/640,974

(22) Filed: Apr. 7, 2026

(30) Foreign Application Priority Data
Apr. 18, 2025 (KR) 10-2025-0051027

(51) Int. Cl. H01G 4/232; H01G 4/252; H01G 4/30

(52) U.S. Cl. CPC H01G 4/2325; H01G 4/252; H01G 4/30

(57) ABSTRACT

A multilayer electronic component includes a body, and an external electrode. The body includes a dielectric layer and an internal electrode alternately disposed with the dielectric layer. The external electrode includes a first electrode layer, a second electrode layer, and a plating layer. The first electrode layer is disposed on a first surface and a second surface of the body and includes Ni. The second electrode layer is disposed on a third surface and a fourth surface of the body to cover a portion of a surface of the first electrode layer, and is connected to the internal electrode. The plating layer covers the first and second electrode layers, and when a length measured from an end of the second electrode layer is defined as BW2 and a length measured from a center of the second electrode layer is defined as BW1, BW1<BW2 is satisfied.

### CROSS-REFERENCE TO RELATED APPLICATION(S)

This application claims benefit of priority to Korean Patent Application No. 10-2025-0051027 filed on Apr. 18, 2025, in the Korean Intellectual Property Office, the disclosure of which is incorporated herein by reference in its entirety.

### TECHNICAL FIELD

The present disclosure relates to a multilayer electronic component.

A Multilayer Ceramic Capacitor (MLCC), a multilayer electronic component, is a chip-shaped capacitor mounted on the printed circuit boards of various electronic devices, including video display devices such as liquid crystal displays (LCD) and plasma display panels (PDP), computers, smartphones, and mobile phones to charge or discharge electricity.

These MLCCs offer the advantages of compact size, high capacitance, and ease of mounting, and may thus be used as components in various electronic devices. As electronic devices such as computers and mobile devices become smaller and more powerful, the demand for miniaturization and high capacitance for the MLCC has increased.

The MLCCs typically have a plating layer including nickel and a plating layer including tin on a base electrode layer to protect the base electrode layer and to provide mechanical connection to a substrate. However, due to differences in composition between the plating layer and the base electrode layer, bonding strength of the plating layer and the base electrode layer may be reduced; thus, measures are needed to improve the bonding strength between the plating layer and the base electrode layer.

Meanwhile, typically the base electrode layer of the MLCC is formed using a Cu sintered electrode, and a thin, uniform Ni electrode layer may be formed on upper and lower surfaces of a body to reduce ESR and ESL. In this case, a Ni electrode layer may be oxidized in a sintering atmosphere of an external electrode or in a process of forming a plating process on the Ni electrode layer, which may reduce the bonding strength between the electrode layer and the plating layer.

Accordingly, even when Ni-containing electrode layers are disposed on upper and lower surfaces of the body, there is a need for structural improvements to the external electrodes to alleviate the deterioration of interlayer bonding strength of the external electrodes due to reduction in bonding strength between the Ni-containing electrode layers and the plating layer.

### SUMMARY

An aspect of the present disclosure is to alleviate the deterioration of interlayer bonding strength of external electrodes due to a reduction in bonding strength between Ni-containing electrode layers and a plating layer when the Ni-containing electrode layers are disposed on upper and lower surfaces of a body.

However, the aspects of the present disclosure are not limited to the above-described content and will be more readily understood in a process of describing specific example embodiments of the present disclosure.

A multilayer electronic component according to an example embodiment of the present disclosure may include: a body including a dielectric layer and an internal electrode alternately disposed with the dielectric layer in a first direction, a first surface and a second surface opposing each other in the first direction, a third surface and a fourth surface opposing each other in a second direction, perpendicular to the first direction, the third surface being connected to one end of the internal electrode, and a fifth surface and a sixth surface opposing each other in a third direction, perpendicular to the first direction and the second direction and spaced apart from the internal electrode; and an external electrode disposed on the body and connected to the internal electrode, and the external electrode may include: a first electrode layer disposed on the first surface and the second surface and including Ni; a second electrode layer disposed on the third surface, and extending from the third surface to cover a portion of a surface of the first electrode layer and connected to the internal electrode; and a plating layer covering the first electrode layer and the second electrode layer, and among second directional lengths of the second electrode layer measured from extension lines of the third surface, when a length measured from a third directional end of the second electrode layer is defined as BW2 and a length measured from a third directional center of the second electrode layer is defined as BW1, BW1<BW2 may be satisfied.

One of the various effects of the present disclosure is to improve bonding strength of an electrode layer and a plating layer of a multilayer electronic component 100 by alleviating the deterioration of the bonding strength of Ni-containing electrode layers and the plating layer even when the Ni-containing electrode layers are disposed on upper and lower surfaces of a body.

However, advantages and effects of the present disclosure are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an example embodiment of the present disclosure;

FIG. 2 schematically illustrates a perspective view of a body according to an example embodiment;

FIG. 3 is a cross-sectional view taken along line I-I of FIG. 1;

FIG. 4 is a cross-sectional view taken along line II-II of FIG. 1;

FIG. 5 is a cross-sectional view taken along line III-III of FIG. 1;

FIG. 6 is a cross-sectional view taken along line IV-IV of FIG. 1;

FIG. 7 is a schematic exploded perspective view illustrating a stacking shape of internal electrodes and dielectric layers according to an example embodiment; and

FIG. 8 is a schematic perspective view of a multilayer electronic component according to an example embodiment.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. Furthermore, the example embodiments disclosed herein are provided for those skilled in the art to better explain the present disclosure. Accordingly, in the drawings, the shapes and dimensions of elements may be exaggerated for clarity, and the same reference numerals will be used throughout to designate the same or like elements.

Furthermore, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. Furthermore, components with the same function within the same range of ideas are described using the same reference numerals. Throughout the specification, when a certain portion “includes” or “comprises” a certain component, this indicates that other components are not excluded and may be further included unless otherwise noted.

The terms “about” or “substantially” are used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” or “substantially” are used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

In the drawing, an X-direction may mean a first direction or a thickness direction, a Y-direction may mean a second direction perpendicular to the X-direction or longitudinal direction, and a Z-direction may mean third direction perpendicular to the X-direction and the Y-direction or a width direction. A stacking direction of internal electrodes 121 and 122 and a dielectric layer 111 may be a thickness direction or a width direction.

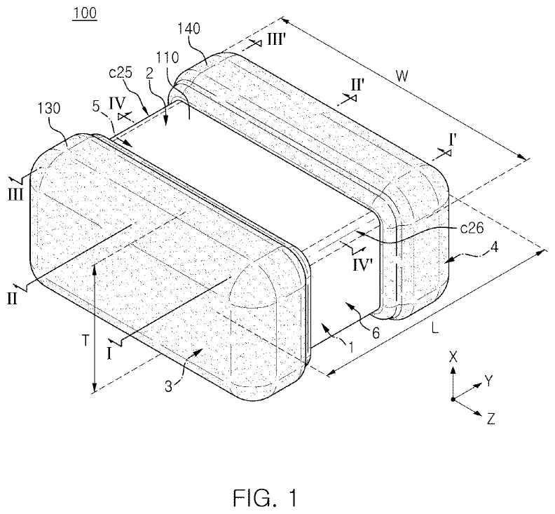

Hereinafter, a multilayer electronic component 100 according to an example embodiment of the present disclosure and various example embodiments thereof will be described in detail with reference to FIGS. 1 to 7.

The multilayer electronic component 100 according to an example embodiment of the present disclosure may include a body 110 and external electrodes 130 and 140. The body 110 may include a dielectric layer 111 and internal electrodes 121 and 122 alternately disposed with the dielectric layer 111 in the first direction. The body 110 may include first and second surfaces 1 and 2 opposing each other in the first direction, third and fourth surfaces 3 and 4 opposing each other in a second direction perpendicular to the first direction and connected to one end of the internal electrodes 121 and 122, and fifth and sixth surfaces 5 and 6 opposing each other in a third direction perpendicular to the first and second directions and spaced apart from the internal electrodes 121 and 122. The external electrodes 130 and 140 may be disposed on the body 110 and connected to internal electrodes 121 and 122. The external electrodes 130 and 140 may include first electrode layers 131 and 141 each disposed on the first surface 1 and the second surface 2. The first electrode layers 131 and 141 may each include Ni. The external electrodes 130 and 140 may include second electrode layers 132 and 142 respectively disposed on the third surface 3 and the fourth surface 4 and extending from each of the third surface 3 and the fourth surface 4 to cover a portion of surfaces of the first electrode layers 131 and 141. The external electrodes 130 and 140 may include plating layers 133, 134, 143 and 144 each covering the first electrode layers 131 and 141 and the second electrode layers 132 and 142. Among second directional lengths of the second electrode layers 132 and 142 measured from extension lines of the third surface and the fourth surface 3 and 4, when a length measured from a third directional end is defined as BW2, and a length measured from a third direction center of the second electrode layers 132 and 142 is defined as BW1, BW1<BW2 may be satisfied.

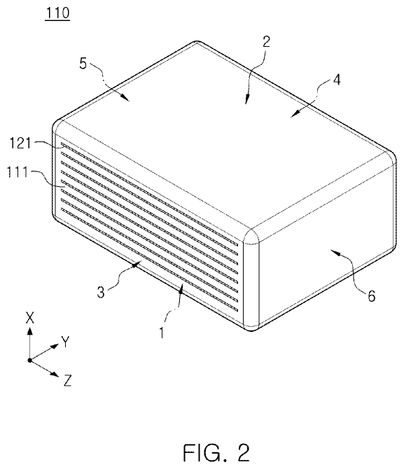

Although there are no specific limitations on the specific shape of the body 110, the body 110 may be formed in a hexahedral shape or a similar shape, as illustrated in FIG. 2. Due to shrinkage of ceramic powder particles included in the body 110 during a sintering process, the body 110 may not be a perfectly straight hexahedral shape but may have a substantially hexahedral shape.

Referring to FIG. 2, the body 110 may include the first and second surfaces 1 and 2 opposing each other in the first direction (e.g., the X-direction), third and fourth surfaces 3 and 4 opposing each other in the second direction (e.g., the Y-direction), perpendicular to the first direction, and fifth and sixth surfaces 5 and 6 opposing each other in the third direction (e.g., the Z-direction) perpendicular to the first and second directions.

Referring to FIGS. 2 to 5, the third surface 3 and the fourth surface 4 may be surfaces connected to one end of the internal electrodes 121 and 122, and referring to FIG. 1, the fifth surface 5 and the sixth surface 6 may be surfaces spaced apart from the internal electrodes 121 and 122.

The dielectric layer 111 may be provided as a plurality of dielectric layers 111 forming the body 110. The dielectric layers 111 may be in a sintered state, and boundaries between adjacent dielectric layers 111 may be integrated to be difficult to identify without using a scanning electron microscope (SEM).

The raw material included in the dielectric layers 111 is not particularly limited, as long as the material may achieve sufficient electrostatic capacity. For example, barium titanate-based materials, lead composite perovskite-based materials, or strontium titanate-based materials may be used as the material. The barium titanate-based material may include BaTiO₃-based ceramic powder particles, and examples of the ceramic powder particles may include BaTiO₃, and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1), which is formed by partially employing calcium (Ca) and zirconium (Zr) in BaTiO₃. Furthermore, the raw material included in the dielectric layer 111 may be obtained by adding various ceramic additives, organic solvents, binders, dispersants, or the like, to powder particles such as barium titanate (BaTiO₃), depending on the purpose of the present disclosure.

A thickness of the dielectric layer 111 need not be particularly limited. In order to achieve the miniaturization and high capacitance of the multilayer electronic component 100, an average thickness of the dielectric layer 111 may be 0.35 μm or less, and in order to improve the reliability of the multilayer electronic component 100 under high temperature and high voltage, the average thickness of the dielectric layer 111 may be 5 μm or greater.

The average thickness of the dielectric layer 111 may refer to an average thickness of one or more dielectric layers 111 in the first direction, among a plurality of dielectric layers. The thickness of the dielectric layer 111 may refer to an average thickness of the dielectric layer 111 in the first direction.

An average thickness of the dielectric layer 111 in the first direction may be measured by scanning images of the first and second directional cross-sections of the body 110 using a scanning electron microscope (SEM) at 10,000× magnification. More specifically, the average thickness of a single dielectric layer 111 in the first direction may refer to an average value calculated by measuring first directional thicknesses of a single dielectric layer 111 at four or more points spaced apart from each other by equal intervals in the second direction in the scanned image. The four or more equally spaced points may be designated by a capacitance formation portion Ac. Furthermore, when an average value is measured by expanding the average value measurement to four or more dielectric layers 111, the average thickness of the dielectric layer 111 in the first direction may be further generalized.

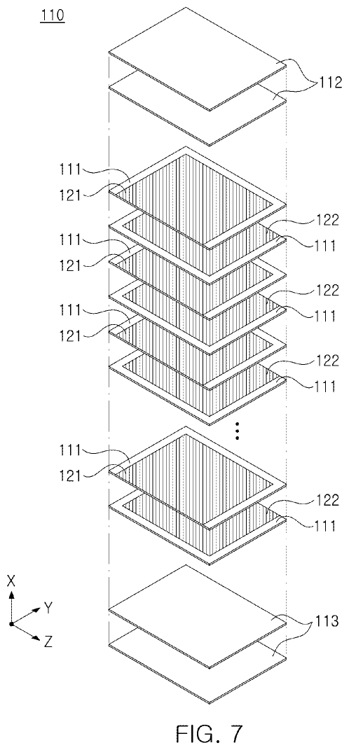

Referring to FIG. 7, the internal electrodes 121 and 122 may be alternately stacked with the dielectric layer 111 forming the body 110.

The internal electrodes 121 and 122 may include the first internal electrode 121 and the second internal electrode 122. The first and second internal electrodes 121 and 122 may be alternately disposed to face each other with the dielectric layer 111 forming the body 110 interposed therebetween. The internal electrodes 121 and 122 may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. The first external electrode 130 may be disposed on the third surface 3 of the body 110 and connected to the first internal electrode 121, and the second external electrode 140 may be disposed on the fourth surface 4 of the body 110 and connected to the second internal electrode 122.

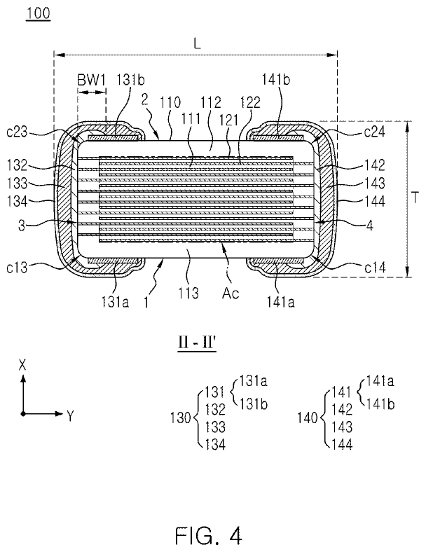

That is, referring to FIG. 4, the first internal electrode 121 may not be connected to the second external electrode 140 and may be connected to the first external electrode 130, and the second internal electrode 122 may be connected to the first external electrode 130 and may be connected to the second external electrode 140. At this time, the first and second internal electrodes 121 and 122 may be electrically isolated from each other by the dielectric layer 111 disposed therebetween.

Meanwhile, the body 110 may be formed by alternately stacking a ceramic green sheet in which the first internal electrode 121 is printed and a ceramic green sheet in which the second internal electrode 122 is printed and then sintering the ceramic green sheets.

The material included in the internal electrodes 121 and 122 is not particularly limited, and any material having excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof.

Additionally, the internal electrodes 121 and 122 may be formed by printing a conductive paste for internal electrodes, including one or more of nickel (Ni), copper (Cu), palladium (Pd), silver (Ag), gold (Au), platinum (Pt), tin (Sn), tungsten (W), titanium (Ti) and alloys thereof, onto a ceramic green sheet. A printing method for the conductive paste for internal electrodes may use a screen-printing method or a gravure printing method, but the present disclosure is not limited thereto.

Meanwhile, a thickness of the internal electrodes 121 and 122 need not be particularly limited.

In order to achieve the miniaturization and high capacitance of the multilayer electronic component 100, an average thickness of the internal electrodes 121 and 122 may be 0.35 μm or less, and in order to improve the reliability of the multilayer electronic component 100 under high temperature and high voltage conditions, the average thickness of the internal electrodes 121 and 122 may be 1 μm or more.

The average thickness of the internal electrodes 121 and 122 may refer to an average thickness of one or more of the internal electrodes 121 and 122 in the first direction, among the plurality of internal electrodes 121 and 122.

An average thickness of the internal electrodes 121 and 122 in the first direction may be measured by scanning images of the first and second directional cross-sections of the body 110 using a scanning electron microscope (SEM) at 10,000× magnification. More specifically, for example, the average thickness of an internal electrode in the first direction may be an average value calculated by measuring first directional thicknesses of the internal electrode at four or more points spaced apart from each other by equal intervals in the second direction in the scanned image. The four or more equally spaced points may be designated by the capacitance formation portion Ac. Furthermore, when the average value is measured by expanding this average value measurement to four or more internal electrodes 121 and 122, the average thickness of the internal electrodes 121 and 122 in the first direction may be further generalized.

Meanwhile, referring to FIG. 4, the body 110 may include cover portions 112 and 113 disposed on both end surfaces of the capacitance formation portion Ac in the first direction.

The cover portions 112 and 113 may be formed by stacking a single dielectric layer 111 or two or more dielectric layers 111 on an upper surface and a lower surface of the capacitance formation portion Ac in the first direction, respectively, and the cover portions 112 and 113 may fundamentally prevent damage to the internal electrodes 121 and 122 due to physical or chemical stress.

The cover portions 112 and 113 do not include the internal electrodes 121 and 122 and may include the same material as the dielectric layer 111. That is, the cover portions 112 and 113 may include a ceramic material, and may include, for example, a barium titanate (BaTiO₃)-based ceramic material.

Meanwhile, a thickness of the cover portions 112 and 113 need not be particularly limited. However, to more easily achieve the miniaturization and high capacitance of multilayer electronic components, the thickness of the cover portions 112 and 113 may be 100 μm or less, preferably 30 μm or less, and more preferably 20 μm or less for ultra-small products.

Here, the thickness of the cover portions 112 and 113 may refer to a first directional thickness of the cover portions 112 and 113. Furthermore, the thickness of the cover portions 112 and 113 may refer to an average thickness of the cover portions 112 and 113 in the first direction.

The average thickness of the cover portions 112 and 113 in the first direction may be measured by scanning images the first and second directional cross-sections of the body 110 using a scanning electron microscope (SEM) at 10,000× magnification. More specifically, the average thickness may be an average value calculated by measuring the first directional thicknesses of one cover portion at 30 points spaced apart from each other by equal intervals in the second direction in the scanned image.

Furthermore, an average thickness of the cover portions 112 and 113 in the first direction, measured using the aforementioned method, may have substantially the same thickness as an average thickness of the cover portion in first and third directional cross-sections of the body 110.

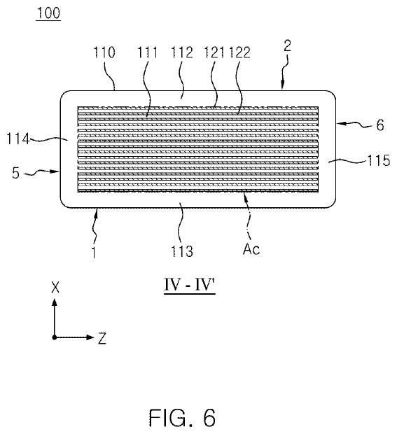

Meanwhile, referring to FIG. 6, margin portions 114 and 115 may be disposed on both surfaces of the capacitance formation portion Ac opposing each other in the third direction.

As illustrated, the margin portions 114 and 115 may refer to a region between both ends of the internal electrodes 121 and 122 in the third direction and a boundary surface of the body 110, based on the first and third directional cross-sections of the body 110.

The margin portions 114 and 115 may fundamentally serve to prevent damage to the internal electrodes 121 and 122 due to physical or chemical stress.

The margin portions 114 and 115 may be formed by applying a conductive paste to the ceramic green sheet, except where the margin portions 114 and 115 are to be formed, to form internal electrodes 121 and 122, and, in order to suppress step portions caused by the internal electrodes 121 and 122, cutting the internal electrodes 121 and 122 after stacking so as to be exposed to the fifth and sixth surfaces 5 and 6 of the body 110, and then stacking a single dielectric layer 111 or two or more dielectric layers 111 in the third direction on both end surfaces of the capacitance formation portion Ac in the third direction.

The margin portions 114 and 115 do not include the internal electrodes 121 and 122 and may include the same material as the dielectric layer 111. That is, the margin portions 114 and 115 may include a ceramic material, and may include, for example, a barium titanate (BaTiO₃)-based ceramic material.

Meanwhile, a width of the margin portions 114 and 115 need not be particularly limited.

However, in order to more easily achieve the miniaturization and high capacitance of the multilayer electronic component 100, the width of the margin portions 114 and 115 may be 100 μm or less, preferably 30 μm or less, and more preferably 20 μm or less for ultra-small products.

Here, the width of the margin portions 114 and 115 may refer to a third directional width of each of the margin portions 114 and 115. Additionally, the width of the margin portions 114 and 115 may refer to an average width of the margin portions 114 and 115 and may refer to the average width of the margin portions 114 and 115 in the third direction.

The average width of the margin portions 114 and 115 in the third direction may be measured by scanning images of the first and third directional cross-sections of the body 110 using a scanning electron microscope (SEM) at 10,000× magnification. More specifically, the average width may refer to an average value calculated by measuring third directional widths of one margin portion at 10 points spaced apart from each other by equal intervals in the first direction in the scanned image.

Referring to FIG. 1, the external electrodes 130 and 140 are disposed on the body 110.

The external electrodes 130 and 140 may include the first electrode layers 131 and 141 each disposed on the first surface 1 and the second surface 2 and including Ni. That is, the first external electrode 130 may include the first electrode layer 131 having a first-first electrode layer portion 131a disposed on the first surface 1 and a second-first electrode layer portion 131b disposed on the second surface 2. The second external electrode 140 may include a first-first electrode layer portion 141a disposed on the first surface 1 and a second-first electrode layer portion 141b disposed on the second surface 2. Further, the external electrodes 130 and 140 may include the second electrode layers 132 and 142 respectively disposed on the third surface 3 and the fourth surface 4 and extending from each of the third surface 3 and the fourth surface 4 to cover a portion of the surfaces of the first electrode layers 131 and 141.

The first electrode layers 131 and 141 may be connected to the second electrode layers 132 and 142 and may each be disposed on the first surface 1 and the second surface 2. The first electrode layers 131 and 141 may thus serve to reduce the equivalent series resistance (ESR) and equivalent series inductance (ESL). Meanwhile, the first electrode layers 131 and 141 may each being disposed on the first surface 1 and the second surface 2 may also serve to prevent external moisture and plating solution from penetrating into corners c12, c23, c14 and c24 of the body 110 in which the external electrodes 130 and 140 are not sufficiently thickly applied. Accordingly, the ESR and ESL of the multilayer electronic component 100 may be reduced and moisture resistance reliability may be improved.

The second electrode layers 132 and 142 may be respectively disposed on the third surface 3 and the fourth surface 4, but may extend from each of the third surface 3 and the fourth surface 4 to cover a portion of the surfaces of the first electrode layers 131 and 141. The second electrode layers 132 and 142 may be connected to the internal electrodes 121 and 122 and may serve to electrically connect the internal electrodes 121 and 122 to the external electrodes 130 and 140.

For a more specific example of the second electrode layers 132 and 142, the second electrode layers 132 and 142 may be sintered electrodes including a conductive metal and glass.

In an example embodiment, the second electrode layers 132 and 142 may include copper and glass. In this case, a bonding strength between the second electrode layers 132 and 142 and the plating layers 133, 143, 134 and 144 may be further improved due to the glass included in the second electrode layers 132 and 142.

In an example embodiment, the second electrode layers 132 and 142 may include Cu at 90 atomic percent (at %) or more relative to the total elements excluding oxygen included in the second electrode layers 132 and 142 or may not include glass. In this case, the second electrode layers 132 and 142 may be formed thinly and uniformly.

In an example embodiment, when the second electrode layers 132 and 142 include Cu as the conductive metal, the connectivity with the internal electrodes 121 and 122 may be improved, and in order to further improve the connectivity with the internal electrodes 121 and 122, the second electrode layers 132 and 142 may further include one or more of nickel (Ni), palladium (Pd), silver (Ag), gold (Au), platinum (Pt), tin (Sn), tungsten (W) and titanium (Ti) in addition to Cu.

A method of forming the second electrode layers 132 and 142 is not particularly limited, and the second electrode layers 132 and 142 may be formed by applying and sintering a paste including a conductive metal and glass onto the body 110, or by plating the conductive metal.

In an example embodiment, the second electrode layers 132 and 142 may ensure electrical conductivity through direct contact with at least a portion of ends of the internal electrodes 121 and 122. That is, the second electrode layers 132 and 142 may be in contact with at least a portion of the internal electrodes 121 and 122.

Meanwhile, nickel (Ni) included in the first electrode layers 131 and 141 may be oxidized during a sintering process of the external electrodes 130 and 140 or during a process of forming the plating layers 133, 134, 143 and 144, disposing an oxide containing Ni between the first electrode layers 131 and the second electrode layers 132 and 142. The Ni-containing oxides may reduce the bonding strength between the second electrode layers 132 and 142 and the plating layers 133, 143, 134 and 144, and thus, the plating layers 133, 143, 134 and 144 may be peeled off from the second electrode layers 132 and 142.

Specifically, in a conventional case in which the first electrode layers 131 and 141 are formed only on the third surface 3 and the fourth surface 4 and the entire upper surfaces of the second electrode layers 132 and 142 are in contact with the plating layers 133, 143, 134 and 144, the problem of peeling off the plating layers 133, 143, 134 and 144 from the second electrode layer due to oxidation of Ni included in the first electrode layers 131 and 141 may be further aggravated.

On the other hand, according to an example embodiment of the present disclosure, the second electrode layers 132 and 142 may be disposed to cover a portion of the surfaces of the first electrode layers 131 and 141, so that Ni oxidation of the first electrode layers 131 and 141 described above may be reduced. Furthermore, a bonding area between the first electrode layers 131 and 141 and the second electrode layers 132 and 142 may be increased, thereby improving the electrical connectivity between the first electrode layers 131 and 141 and the second electrode layers 132 and 142. Accordingly, the effect of reducing the ESR of the multilayer electronic component 100 may be enhanced, and the moisture resistance reliability may also be further improved.

Meanwhile, the third directional ends of the first electrode layers 131 and 141 and the second electrode layers 132 and 142 are located at regions adjacent to a corner c25 connecting the second surface 2 and the fifth surface 5 of the body 110, a corner c26 connecting the second surface 2 and the sixth surface 6, a corner (not illustrated) connecting the first surface 1 and the fifth surface 5, and corner (not illustrated) connecting the first surface 1 and the sixth surface 6, and thus, the third directional ends thereof may be regions particularly weak in bonding between the first electrode layers 131 and 141 and the plating layers 133, 143, 134 and 144.

Accordingly, in an example embodiment of the present disclosure, a second directional length of each of the second electrode layers 132 and 142, measured from extension lines of the third surface 3 and the fourth surface 4 of the body 110, may be formed so that the second directional length of the second electrode layers 132 and 142 at a third directional end of the second electrode layers 132 and 142 is longer than a the second directional length of the second electrode layers 132 and 142 at a third direction center thereof, thereby alleviating the phenomenon of peeling off the plating layers 133, 143, 134 and 144 from the second electrode layers 132 and 142.

A method of measuring the second directional length of the second electrode layers 132 and 142 for each third directional point, measured from the extension lines of the third surface 3 and the fourth surface 4, is not particularly limited.

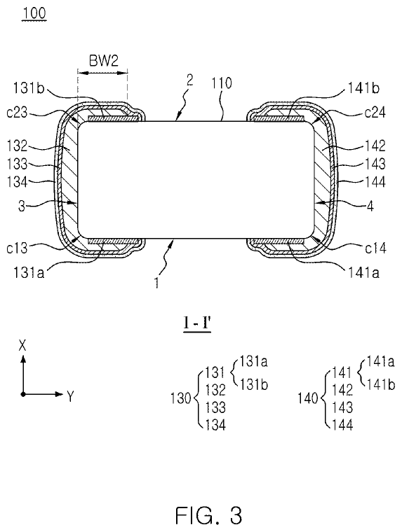

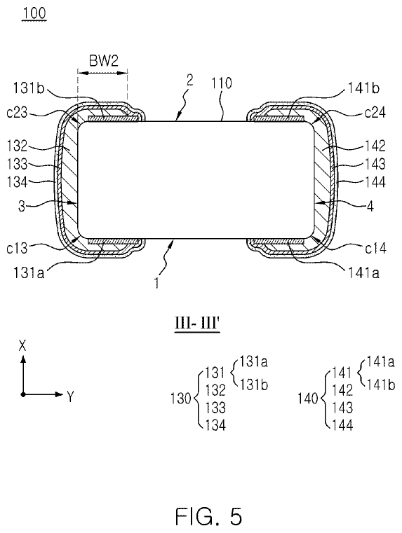

FIG. 3 illustrates a first and second directional cross-section of the multilayer electronic component 100 according to FIG. 1, polished to the corner c26 connecting the second surface 2 and the sixth surface 6 thereof (e.g., at a one of the third directional ends of the second electrode layers 132 and 142), FIG. 4 illustrates a first and second directional cross-section of the multilayer electronic component 100 according to FIG. 1, polished to a third directional center thereof, and FIG. 5 illustrates a first and second directional cross-section of the multilayer electronic component 100 according to FIG. 1, polished to the corner c25 connecting the second surface 2 and the fifth surface 5 or polished until the surface is exposed (e.g., at the other of the third directional ends of the second electrode layers 132 and 142). In each of the cross-sections of FIGS. 3, 4 and 5 described above, a damage layer of the surface of the cross-sections may be removed using xenon (Xe) or argon (Ar) ion milling, and then the cross-sections may be observed using an optical microscope (OM), a scanning electron microscope (SEM), or a transmission electron microscope (TEM), and the second directional length of the second electrode layers 132 and 142 measured from the extension lines of the third surface 3 and the fourth surface 4 in each cross-section may be measured using an image processing program, or the like. Meanwhile, the second directional length of the second electrode layers 132 and 142 measured from the extension lines of the third surface 3 and the fourth surface 4 may refer to a second directional length between ends of the second electrode layers 132 and 142 disposed on the first electrode layers 131 and 141 from the extension lines of the third surface 3 and the fourth surface 4.

Referring to FIGS. 3 to 5, among the second directional lengths of the second electrode layers 132 and 142 measured from the extension lines of the third surface 3 and the fourth surface 4 according to an example embodiment of the present disclosure, a second directional length measured from the third directional end of the second electrode layers 132 and 142 may be defined as BW2, and a second directional length measured from the third directional center of the second electrode layers 132 and 142 may be defined as BW1, and BW1 and BW2 may satisfy BW1<BW2, and more preferably, (2×BW1)≤BW2.

In an example embodiment, the content of Ni elements relative to the total elements excluding oxygen included in in the first electrode layers 131 and 141 may be 90 at % or more, and in an example embodiment, the first electrode layers 131 and 141 may not include glass. Accordingly, thicknesses of the external electrodes 130 and 140 in the first direction may be reduced, and the multilayer electronic component 100 having a thin thickness in the first direction may be implemented. In this case, the first electrode layers 131 and 141 may be formed by nickel plating on the first surface 1 and the second surface 2 of the body 110.

In an example embodiment, the external electrodes 130 and 140 may further include an oxide including nickel, which is disposed on the first electrode layers 131 and 141 and the second electrode layers 132 and 142. As described above, an oxide including Ni may be formed by oxidation of Ni included in the second electrode layers 132 and 142 during the formation of the plating layers 133, 143, 134 and 144, and may cause a decrease in the bonding strength between the second electrode layers 132 and 142 and the plating layers 133, 143, 134 and 144. However, according to an example embodiment of the present disclosure, the second directional length of the second electrode layers 132 and 142, measured from the extension lines of the third surface 3 and the fourth surface 4, may be formed to be longer at the third directional end of the second electrode layers 132 and 142 than at the third directional center thereof, so that the phenomenon of peeling off the plating layers 133, 143, 134 and 144 from the second electrode layers 132 and 142 may be mitigated, thereby effectively preventing a reduction in the bonding strength between the second electrode layers 132 and 142 and the plating layers 133, 143, 134 and 144.

The plating layers 133, 143, 134 and 144 may serve to improve the sealing properties and the mounting characteristics of the multilayer electronic component 100.

The type of plating layers 133, 143, 134 and 144 is not particularly limited, and may each be a single layer including one or more of nickel (Ni), tin (Sn), silver (Ag), palladium (Pd) and alloys thereof, or may be comprised of a plurality of layers.

In an example embodiment, the plating layers 133, 143, 134 and 144 may include first plating layers 133 and 143 disposed on the first electrode layers 131 and 141 and the second electrode layers 132 and 142 and including Ni, and second plating layers 134 and 144 disposed on the first plating layers 133 and 143 and including Sn.

The composition of the first electrode layers 131 and 141, the second electrode layers 132 and 142, and the plating layers 133, 143, 134 and 144 may be analyzed using the Energy Dispersive X-ray Spectroscopy (EDS) mode of a scanning electron microscope (SEM), the EDS mode of a transmission electron microscope (TEM), or the EDS mode of a scanning transmission electron microscope (STEM). First, a thinned sample is prepared using a focused ion beam (FIB) device in a region to be measured. In the thinned sample, a damage layer of a surface thereof is removed using xenon (Xe) or argon (Ar) ion milling, and then, each component to be measured is mapped in an image obtained using SEM-EDS, TEM-EDS or STEM-EDS and is subject to qualitative and quantitative analysis. In this case, a qualitative and quantitative analysis graph for each component may be converted to a content of each element, for example, mass percent (wt %), atomic percent (at %) or molar percent (mol %), and the converted results are expressed, and the graph may also represent the content of other specific components relative to the content of certain components.

In an example embodiment, since the second electrode layers 132 and 142 are disposed to cover a portion of the surfaces of the first electrode layers 131 and 141, portions of the first electrode layers 131 and 141 may include a region not covered with the second electrode layers 132 and 142. In this case, the first electrode layers 131 and 141 not covered with the second electrode layers 132 and 142 may be in contact with the plating layers 133 and 143. Meanwhile, in a conventional case, ends of the first electrode layers 131 and 141 and the body 110 may not be in close contact due to differences in the degree of shrinkage and expansion during sintering, which may reduce the bonding strength between the multilayer electronic component 100 and the external electrodes 130 and 140. However, in an example embodiment, the ends of the first electrode layers 131 and 141 not covered with the second electrode layers 132 and 142 may be in contact with the body 110 and the plating layers 133, 143, 134 and 144, thereby alleviating the deterioration of the bonding strength between the multilayer electronic component 100 and the external electrodes 130 and 140.

In an example embodiment, the second electrode layers 132 and 142 may include a connection portion, which is a region disposed on the third surface 3 and the fourth surface 4, and a band portion, which is a region disposed on the first surface 1 and the second surface 2, and an average thickness of the band portion may be less than an average thickness of the connection portion. Accordingly, the multilayer electronic component 100 having a thin thickness in the first direction may be realized.

In an example embodiment, the first electrode layers 131 and 141 may be spaced apart from an internal electrode disposed in an uppermost end in the first direction and an internal electrode disposed in a lowermost end in the first direction, among the internal electrodes 121 and 122. Accordingly, the first electrode layers 131 and 141 may not be directly connected to the internal electrodes 121 and 122, and thus, the multilayer electronic component 100 having a thin thickness in the first direction may be implemented.

In an example embodiment, the body 110 may include the corner c13 connecting the first surface 1 and the third surface 3, the corner c14 connecting the first surface 1 and the fourth surface 4, the corner c23 connecting the second surface 2 and the third surface 3, and the corner c24 connecting the second surface 2 and the fourth surface 4.

Meanwhile, in an example embodiment, the first electrode layers 131 and 141 may be disposed on the first surface 1 and the second surface 2, but may not extend on the corner c13 connecting the first surface 1 and the third surface 3, the corner c14 connecting the first surface 1 and the fourth surface 4, the corner c23 connecting the second surface 2 and the third surface 3, or the corner c24 connecting the second surface 2 and the fourth surface 4. Accordingly, the multilayer electronic component 100 having a thin thickness in the first direction may be realized.

Referring to FIG. 1, a size of the multilayer electronic component 100 may be expressed as a maximum thickness T in the first direction, a maximum length L in the second direction, and a maximum width W in the third direction.

In an example embodiment, in order to reduce the equivalent series inductance (ESL) of the multilayer electronic component 100, a structure of reducing a distance between the first external electrode 130 and the second external electrode 140 in the second direction may be applied.

Specifically, the multilayer electronic component 100 according to an example embodiment may satisfy W>L, and more preferably, L/W≤0.8. Accordingly, a structure of reducing the distance between the first external electrode 130 and the second external electrode 140 in the second direction may be implemented to reduce the ESL of the multilayer electronic component 100.

Meanwhile, the ESL of the multilayer electronic component 100 may also be affected by the maximum thickness T in the first direction. Specifically, the multilayer electronic component 100 according to an example embodiment may satisfy W>T, and more preferably, T/W≤0.8. Accordingly, an area of a current loop formed in the multilayer electronic component 100 may be reduced to reduce the ESL. In this case, the maximum thickness T of the multilayer electronic component 100 in the first direction may be 500 μm or less, but the present disclosure is not limited thereto.

For a multilayer electronic component 100 that satisfies W>T, the first electrode layers 131 and 141 disposed on the first surface 1 or the second surface 2 of the body 110 being formed with plating layers 133, 134, 143 and 144 of nickel may be advantageous in reducing the maximum size of the multilayer electronic component 100 in the first direction. In this case, oxidation of the first electrode layers 131 and 141 may occur due to the influence of the sintering atmosphere of the entire external electrodes 130 and 140, or an additional plating process, and the oxidation of the first electrode layers 131 and 141 may cause a problem of reducing the bonding strength between the plating layers 133, 134, 143 and 144 and the first electrode layers 131 and 141.

However, the external electrodes 130 and 140 according to an example embodiment of the present disclosure may include the second electrode layers 132 and 142 extending from each of the third surface 3 and the fourth surface 4 to cover a portion of the surfaces of the first electrode layers 131 and 141. Since BW1<BW2 is satisfied, or more preferably (2×BW1)≤BW2 is satisfied, the problem of reduced the bonding strength between the plating layers 133, 134, 143 and 144 and the first electrode layers 131 and 141 may be alleviated.

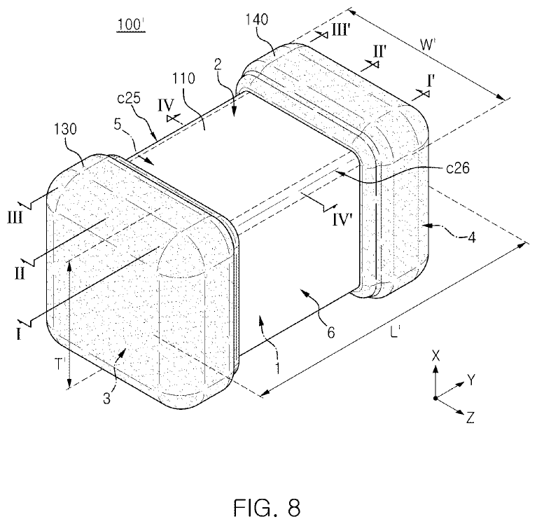

FIG. 8 schematically illustrates a perspective view of a multilayer electronic component according to an example embodiment.

The various example embodiments of the present disclosure described above with respect to FIGS. 1-7 are not limited to the multilayer electronic component 100 having a structure that satisfies W>L or a case in which the maximum thickness T in the first direction is 500 μm or less.

Specifically, referring to FIG. 8, which includes components similar to those of to FIG. 1 except where noted herein, when the maximum thickness in the first direction of a multilayer electronic component 100′ according to an example embodiment is defined as T′, a maximum length thereof in the second direction is defined as L′ and a maximum width thereof in the third direction is defined as W′, the multilayer electronic component 100′ may satisfy W′<L′ or W′<T′. Various example embodiments of the present disclosure may also be applied to a multilayer electronic component 100′ that satisfies W′<L′ or W′<T′, unless otherwise stated.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression an example embodiment’ used in the present disclosure does not mean the same embodiment and is provided to emphasize and explain different unique characteristics. However, the example embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment and are not intended to limit the present disclosure. Singular forms may include plural forms as well unless the context clearly indicates otherwise.

What is claimed is:

1. A multilayer electronic component, comprising:
a body including:
a dielectric layer and an internal electrode alternately disposed with the dielectric layer in a first direction,
a first surface and a second surface opposing each other in the first direction,
a third surface and a fourth surface opposing each other in a second direction, perpendicular to the first direction, the third surface being connected to one end of the internal electrode, and
a fifth surface and a sixth surface opposing each other in a third direction, perpendicular to the first direction and the second direction, and spaced apart from the internal electrode; and
an external electrode disposed on the body and connected to the internal electrode,
wherein the external electrode includes:
a first electrode layer disposed on the first surface and the second surface and including Ni;
a second electrode layer respectively disposed on the third surface, extending from the third surface to cover a portion of a surface of the first electrode layer, and connected to the internal electrode; and
a plating layer covering the first electrode layer and the second electrode layer,
wherein, among second directional lengths of the second electrode layer measured from an extension line of the third surface, when a length measured from a third directional end of the second electrode layer is defined as BW2 and a length measured from a third directional center of the second electrode layer is defined as BW1,
BW1<BW2 is satisfied.

2. The multilayer electronic component according to claim 1, wherein (2×BW1)≤BW2 is satisfied.

3. The multilayer electronic component according to claim 1, wherein the internal electrode includes a plurality of internal electrodes, and
wherein the first electrode layer is spaced apart from an internal electrode disposed in an uppermost end in the first direction and an internal electrode disposed in a lowermost end in the first direction, among the plurality of internal electrodes.

4. The multilayer electronic component according to claim 1, wherein a content of Ni elements relative to all elements excluding oxygen included in the first electrode layer is 90 at % or more.

5. The multilayer electronic component according to claim 1, wherein the first electrode layer does not include glass.

6. The multilayer electronic component according to claim 1, wherein the second electrode layer includes Cu and glass.

7. The multilayer electronic component according to claim 1, wherein the second electrode layer includes Cu, and a content of Cu elements relative to all elements excluding oxygen included in the second electrode layer is 90 at % or more.

8. The multilayer electronic component according to claim 1, wherein the second electrode layer does not include glass.

9. The multilayer electronic component according to claim 1, wherein the second electrode layer is in contact with at least a portion of the internal electrode.

10. The multilayer electronic component according to claim 1, wherein the external electrode further includes an oxide including Ni, which is disposed between the first electrode layer and the second electrode layer.

11. The multilayer electronic component according to claim 1, wherein the plating layer includes a first plating layer disposed on the first electrode layer and the second electrode layer and including Ni, and a second plating layer disposed on the first plating layer and including Sn.

12. The multilayer electronic component according to claim 1, wherein an end of the first electrode layer not covered with the second electrode layer is in contact with the body and the plating layer.

13. The multilayer electronic component according to claim 1, wherein the second electrode layer includes a connection portion, which is a region disposed on the third surface, and a band portion, which is a region disposed on the first surface and the second surface, and
an average thickness of the band portion is smaller than an average thickness of the connection portion.

14. The multilayer electronic component according to claim 1, wherein, when a maximum length of the multilayer electronic component in the second direction is defined as L and a maximum width of the multilayer electronic component in the third direction is defined as W,
W>T is satisfied.

15. The multilayer electronic component according to claim 1, wherein, when a maximum length of the multilayer electronic component in the second direction is defined as L and a maximum width of the multilayer electronic component in the third direction is defined as W,
W>L is satisfied.

16. The multilayer electronic component according to claim 14, wherein, when a maximum size of the multilayer electronic component in the first direction is defined as T,
T≤500 μm is satisfied.
